(19) United States
(12) Patent Application Publication
(10) Pub. No.: US 2007/0262172 A1
(43) Pub. Date: Nov. 15, 2007

(54) Modular Spray Gun with Multiple Control Modules

(75) Inventor: David C. Huffman, Merrimack, NH (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Spraying Systems Co., Wheaton, IL (US)

(21) Appl. No.: 10/552,339

(22) PCT Filed: Mar. 26, 2004
(86) PCT No.: PCT/US04/09112

§ 371 Date: Mar. 20, 2007

Related U.S. Application Data
(60) Provisional application No. 60/457,963, filed on Mar. 27, 2003.

(51) Int. Cl. B05B 1/12

(52) U.S. Cl. 239/390

(57) ABSTRACT

A modular spray gun assembly is provided. The modular spray gun assembly includes a spray gun body, a spray nozzle module and a plurality of control modules. The spray nozzle module is releaseably attachable to a downstream end of the nozzle body with a first retainer that engages a portion of the downstream end of the spray gun body. The plurality of control modules are interchangeably mountable on an upstream end of the spray gun body. A portion of each control module is receivable in a counterbore in the upstream end of the spray gun body. Each control module is releaseably attachable to the spray gun body with a second retainer that engages a portion of the upstream end of the spray gun body.

### FIELD OF THE INVENTION

The present invention relates generally to liquid spray devices, and more particularly, to a spray gun or similar liquid spray device having a spray nozzle assembly at the discharge end and a control or actuating mechanism at an opposite end for controlling the liquid discharge from the spray nozzle assembly.

### BACKGROUND OF THE INVENTION

Liquid spray guns that use air to assist in atomization and direction of the liquid spray and which have an actuator or control mechanism for further regulating the spray discharge are well known. For example, one such spray gun is disclosed in commonly owned U.S. Pat. No. 5,707,010. With such spray guns, both the spray nozzle assembly and control mechanism typically are designed for the particular spray application. While it is customary to selectively establish the spray discharge pattern through the use of a particular spray nozzle or tip, the spray actuator or control mechanism often does not permit easy or quick change over to a different type of control mechanism. Also, it often is desirable to use other accessory devices with such spray guns. Similarly, these accessory devices are not easily adaptable to the spray gun.

### OBJECTS AND BRIEF SUMMARY OF THE INVENTION

Accordingly, in view of the foregoing, an object of the present invention is to provide a modular constructed liquid spray gun that can be more versatilely used in different spray applications.

Another object is to provide a modular spray gun as characterized above in which both spray nozzle modules and control modules can be easily and quickly changed for a desired spray application.

A further object is to provide a modular spray gun of the above kind in which the control modules may be easily replaced with other accessories to facilitate use and/or cleaning of the spray gun.

Still another object is to provide a modular spray gun of the foregoing type that has a plurality of standardized control modules or accessories adapted for interchangeable use with the spray gun.

Other objects and advantages of the invention will become apparent upon reading the following detailed description and upon reference to the drawings, in which:

### BRIEF DESCRIPTION OF THE DRAWINGS

FIG. 1 is a longitudinal section view of an illustrative modular spray gun in accordance with the invention.

FIG. 2 is an exploded section view of the modular spray gun shown in FIG. 1.

FIG. 3 is a side view of the spray gun body of the modular spray gun of FIG. 1

FIG. 4 is a longitudinal section view of an alternative embodiment of a modular spray gun in accordance with the invention that includes a diaphragm sealed single action actuator.

FIG. 5 is an exploded section view of the modular spray gun of FIG. 4.

FIG. 6 is a longitudinal section view of an alternative embodiment of a modular spray gun in accordance with the invention that includes a diaphragm sealed double action actuator.

FIG. 7 is an exploded section view of the modular spray gun of FIG. 6.

FIG. 8 is a longitudinal section view of an alternative embodiment of a modular spray gun in accordance with the invention that includes a single action solenoid actuator.

FIG. 9 is an exploded section view of the modular spray gun of FIG. 8.

FIG. 10 is a longitudinal section view of an alternative embodiment of a modular spray gun in accordance with the invention that includes liquid connection back plug.

FIG. 11 is an exploded section view of the modular spray gun of FIG. 10.

FIG. 12 is a longitudinal section view of an alternative embodiment of a modular spray gun in accordance with the invention that includes a manual liquid metering needle.

FIG. 13 is an exploded section view of the modular spray gun of FIG. 12.

FIG. 14 is a longitudinal section view of an alternative embodiment of a modular spray gun in accordance with the invention that includes a manual clean out needle.

FIG. 15 is an exploded section view of the modular spray gun of FIG. 14.

FIG. 16 is a longitudinal section view of an alternative embodiment of a modular spray gun in accordance with the invention that includes a back plug.

FIG. 17 is an exploded section view of the modular spray gun of FIG. 16.

### DETAILED DESCRIPTION OF THE INVENTION

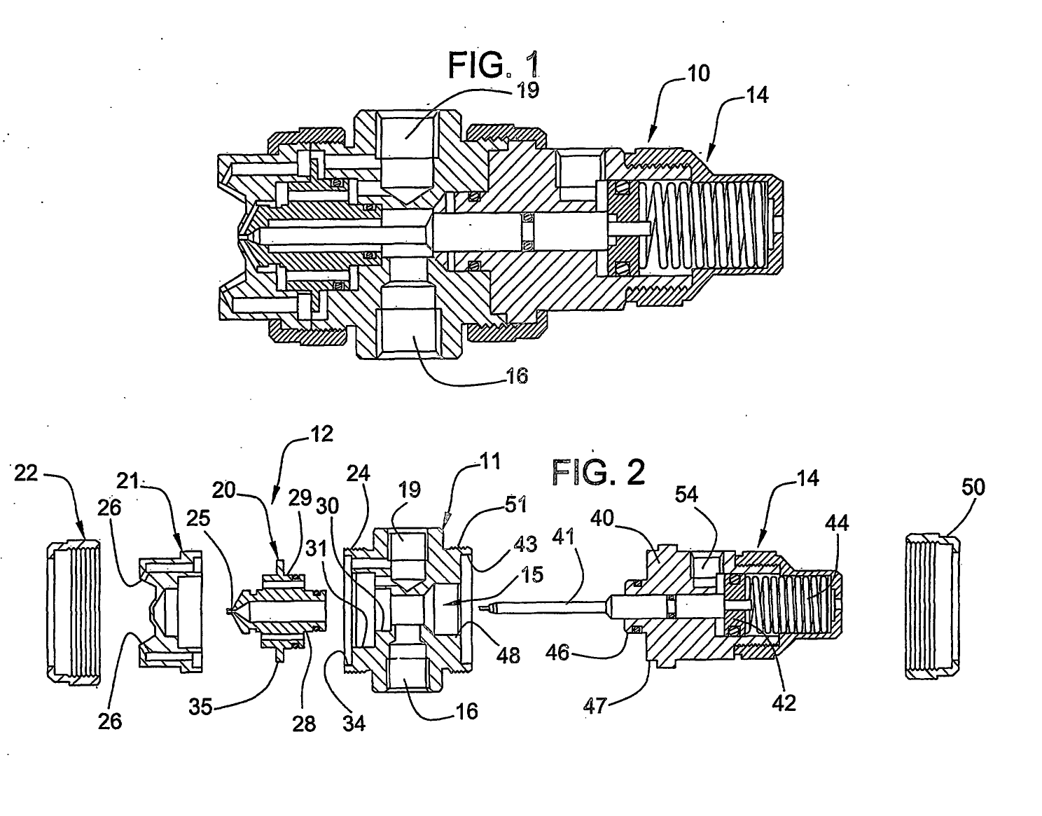

Referring now more particularly to FIGS. 1 and 2 of the drawings, there is shown an illustrative modular spray gun 10 in accordance with the invention, comprising a spray gun body 11 having a spray nozzle assembly or module 12 at a discharge end and a control module 14 at an opposite end thereof for controlling the liquid spray discharge from the nozzle assembly 12. The basic structure and mode of operation of the spray gun are known in the art, for example, as shown in the aforementioned U.S. Pat. No. 5,707,010.

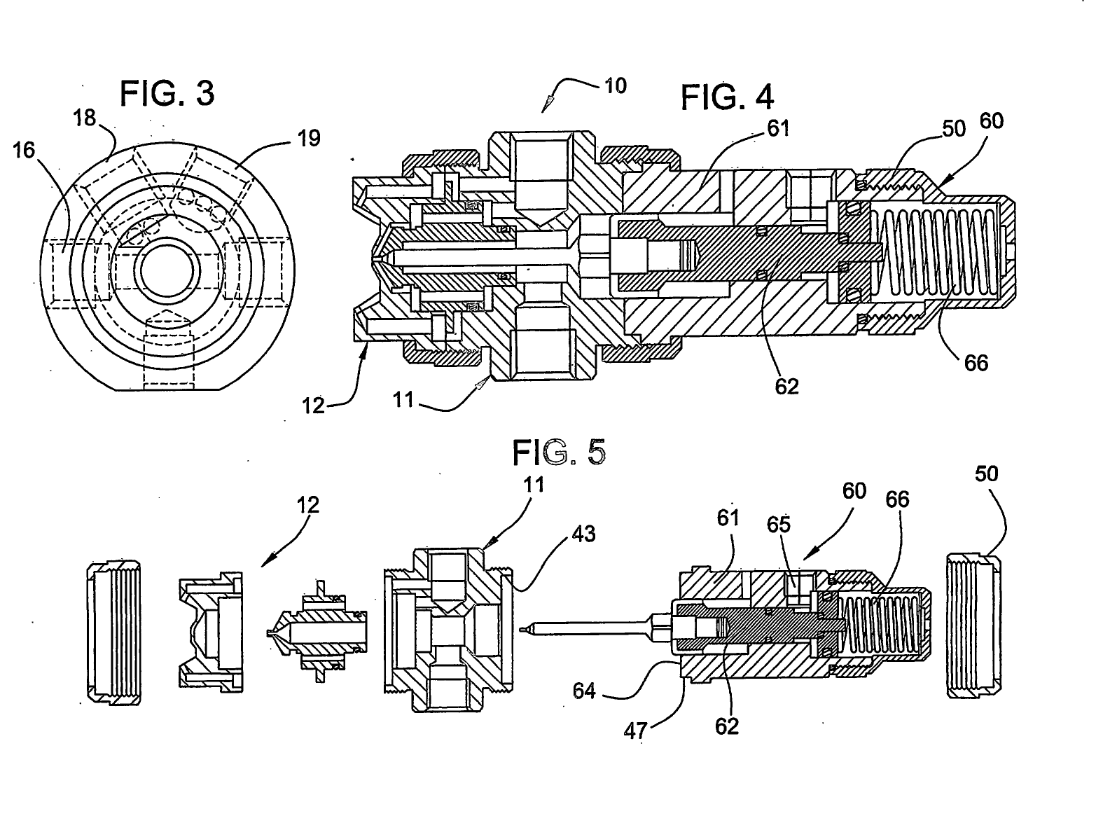

The illustrated spray gun body 11, as depicted in FIGS. 1-3, has an axial liquid flow passage 15 and a plurality of radial fluid passages. The radial passages include a liquid inlet port 16 for connection to a supply liquid to be sprayed and communicating with the liquid flow passage 15, an atomizing air inlet port 18 for connection to a pressurized air source or other pressurized fluid for assisting in atomization of the liquid to be sprayed, and a fan air inlet port 19 also for connection to a pressurized air source for assisting in direction and form of the discharging spray.

The spray nozzle module 12, as depicted in FIGS. 1 and 2, comprises a spray tip 20, an air cap 21 mounted in surrounding relation to the discharge end of the spray tip 20, and a retaining ring 22 mounted on a downstream externally threaded hub 24 of the spray gun body 11. The spray tip 20 in this case has a forwardly extending nose portion 25 which defines a liquid discharge orifice and which extends axially into a central opening of the air cap 21 that defines an annular air discharge orifice through which the atomizing air directed to the spray gun discharges. The air cap 21 further defines opposed passages 26 through which fan air directed to the spray gun discharges to assist in forming of the discharge spray pattern, as is known in the art.

It will be understood that by removal of the retaining ring 22, the spray nozzle 12 module and/or a spray tip 20 thereof may be removed and replaced for a particular spray application. To facilitate such spray tip replacement, the illustrated spray tip 20 has a threadless union with the spray gun body 11 defined by concentric hubs 28, 29 each carrying a respective O-ring for interfitting within corresponding spray tip receiving bores 30, 31 of the nozzle body 11. To facilitate accurate positioning of the spray tip 20 within the spray gun body 11, the spray gun body 11 is formed with a downstream counterbore 34 which receives an annular radial flange 35 of the spray tip 20.

In accordance with an important aspect of the invention, the control module 14 is one of a plurality of standardized spray control modules or accessories that can be quickly and easily interchangeably mounted on the spray gun body 11 for enabling more versatile use of the spray gun for particular spray applications. The control module 14 in the embodiment shown in FIGS. 1-2 includes a body member 40 that carries a shut-off valve needle 41 of a conventional type for reciprocating movement with respect to the spray tip 20. The valve needle 41 has a piston assembly 42 at its opposite end which is biased in a valve closing position by a spring 44 retained within a cap 45 threadedly engaged with an upstream end of the body 40. The body 40 has a downstream relatively small diameter cylindrical hub portion 46 which carries an O-ring that is removably positionable within an upstream cylindrical bore 48 of the spray gun body 11 with a threadless union. To facilitate accurate positioning of the control module 14 in a mounted position on the spray gun body 11, the spray gun body 11 has a counterbore 43 formed in the upstream end for receiving a cylindrical shoulder 47 on the body 40 of the control module.

For releaseably securing the control module 14 in the mounted position, a retainer ring 50 is provided which threadably engages an upstream threaded hub portion 51 of the spray gun body 11. During operation, for axially moving the valve needle 41 to an open position (to the right as viewed in FIG. 1) against the force of the spring 44, control drive air or some other fluid is supplied via an inlet port 54 of the module into a cylinder adjacent a forward side of the movable piston 42. As is known in the art, the control fluid, i.e., compressed air, may be controlled externally, such as by solenoid actuated valves, for controlling sequential opening of the valve needle 41. The threadless junction between the control module 14 and the spray gun body permits easy removal and replacement of the module as an incident to removal of the retaining ring 50.

In carrying out the invention, a multiplicity of standardized modules and spray gun accessories may be used with the modular spray gun 10, as depicted in FIGS. 4-17. As shown in the drawings, all of these control modules and accessories are received in the counter bore 43 in the upstream end of the spray gun body 11 and releaseably secured in place via the retaining ring 50. In FIGS. 4 and 5, a control module 60 is shown which includes a body member 61 with a needle carrying piston 62 having a diaphragm seal 64 affixed to the upstream end of the module body 61. In this case, the module 60 is secured to the spray gun body 11 by the retaining ring 50 with an outer annular portion of the diaphragm seal 64 fixed between the body 11 and module 60. Again, the module 60 has a control air inlet port 65 for opening the valve against the biasing force of a spring 66.

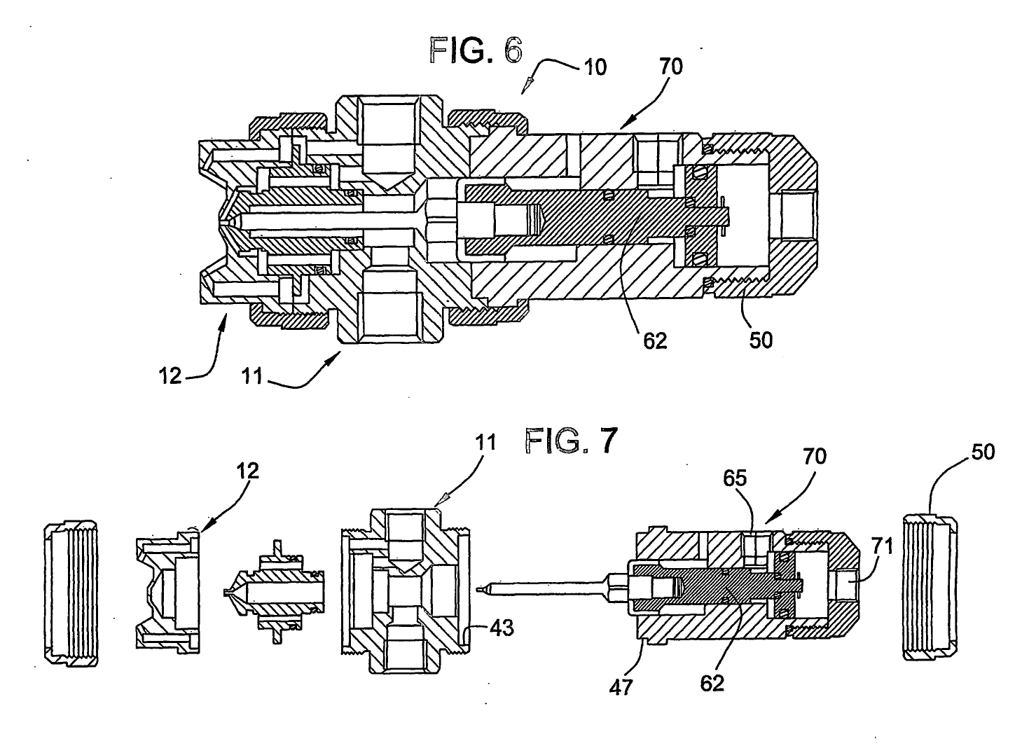

FIGS. 6 and 7 disclose a spray gun with a diaphragm sealed control module 70, similar to that shown in FIGS. 4 and 5, but with a double air-actuatable piston 62. Air inlet lines in this case communicate through inlet ports 65, 71 for respectively moving the piston 62 and valve needle between open and closed positions.

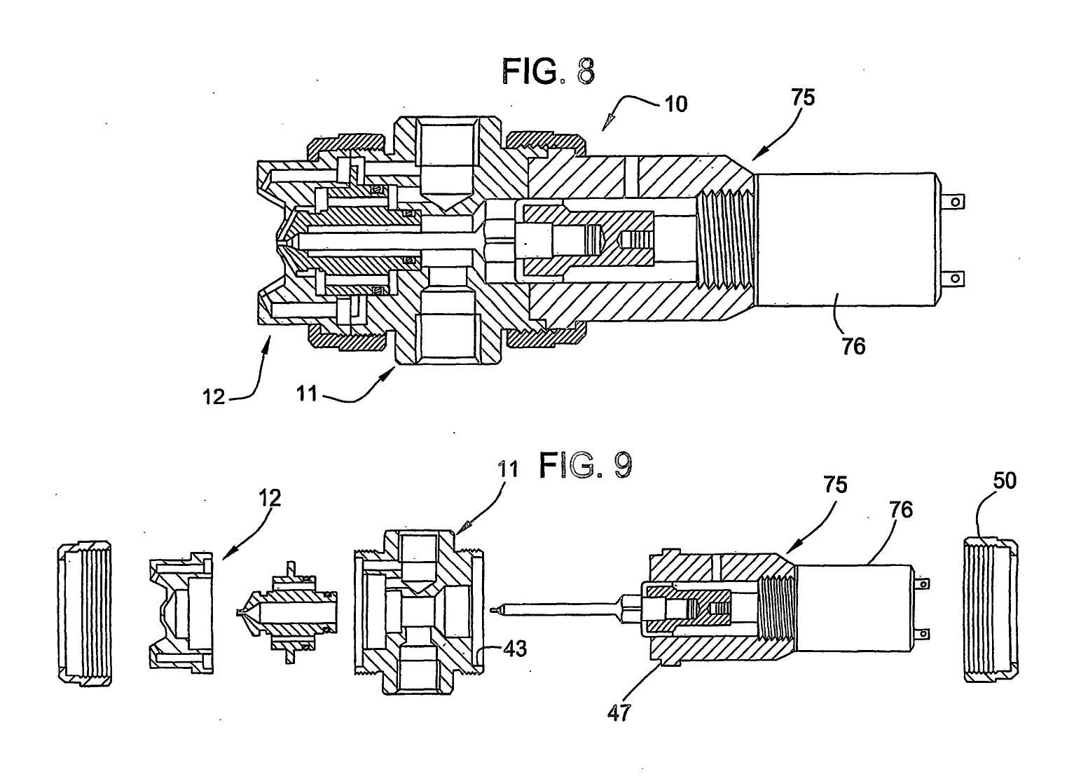

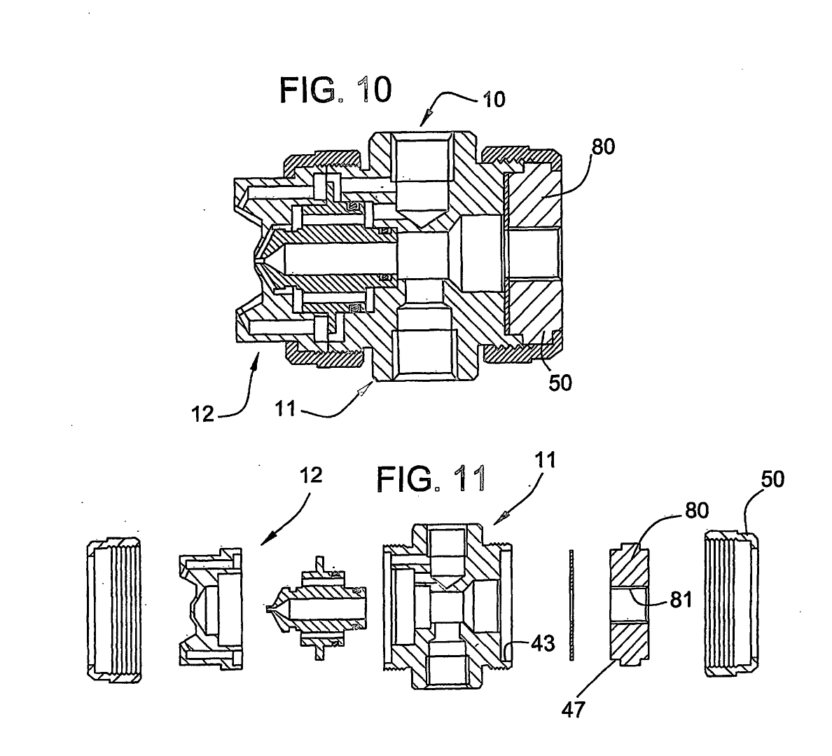

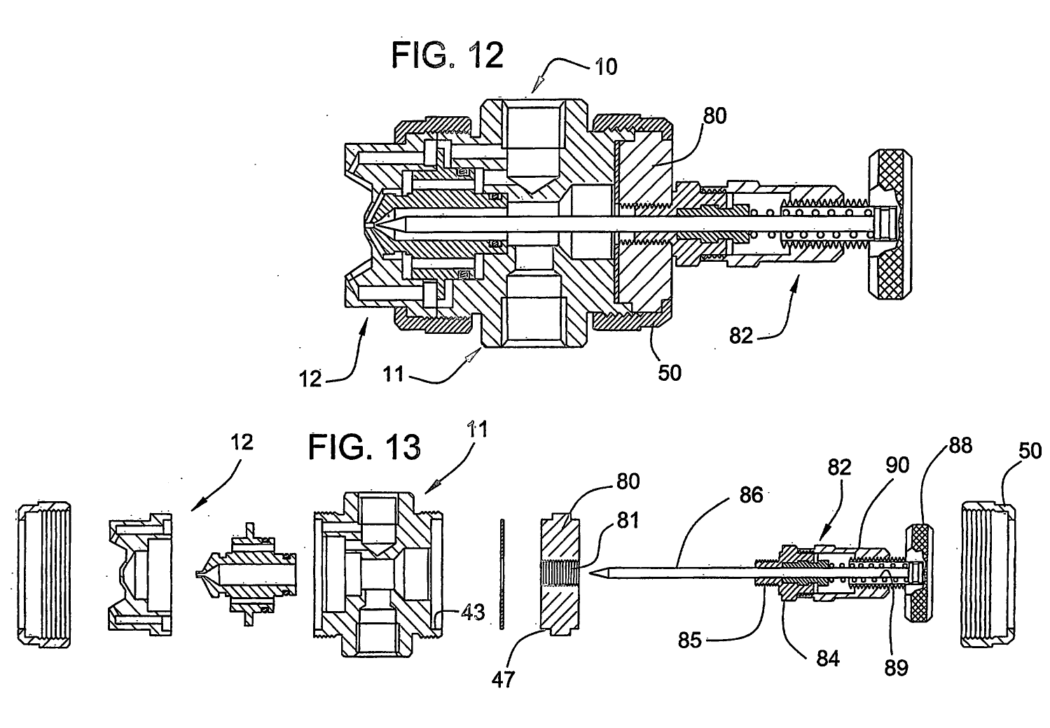

FIGS. 8 and 9 shows the modular spray gun with a control module 75, similar to that shown in FIGS. 4 and 5, but with a solenoid 76 for operating the needle valve between open and closed positions.

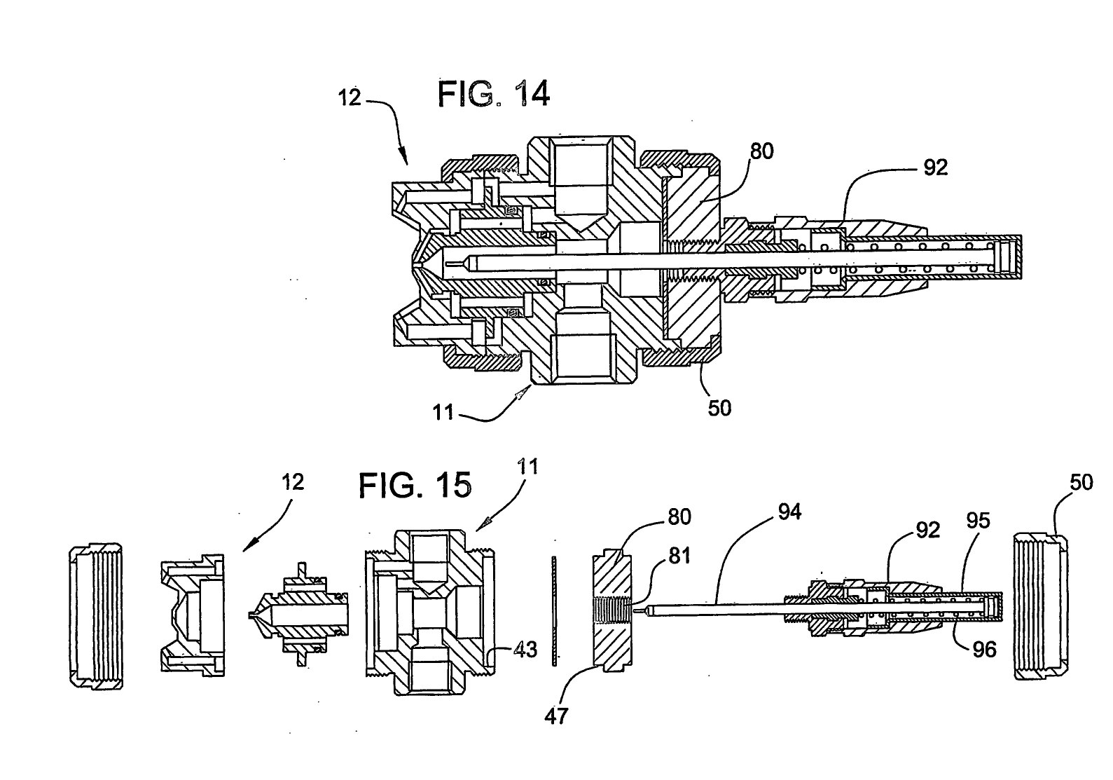

In further keeping with the invention, the modular spray gun can be used with control modules comprising various other spray gun accessories. To this end, as shown in FIGS. 10-11, the spray gun is shown with an accessory receiving plug or plate 80 affixed thereto by the retaining ring 50. The accessory receiving plate 80 in this case has a central threaded bore 81, which can receive various standardized accessories, such as shown in FIGS. 12-15. In FIGS. 12 and 13, a manually operated metering needle assembly 82 is shown which has an body 84 with forward threaded section 85 for engagement with the threaded plug passageway 81. The body 85 supports the metering needle 86, which can be adjustably positioned by a control knob 88 at the upstream end mounted within a threaded aperture 89 of a rearwardly extending housing 90 of the assembly 82. FIGS. 14 and 15 show a clean out needle assembly 92 affixed to the plate 80, which includes a clean out needle 94 that can be manually positioned to a forward clean out position through depression of a rearwardly extending actuating member 95 against the force of a biasing spring 96.

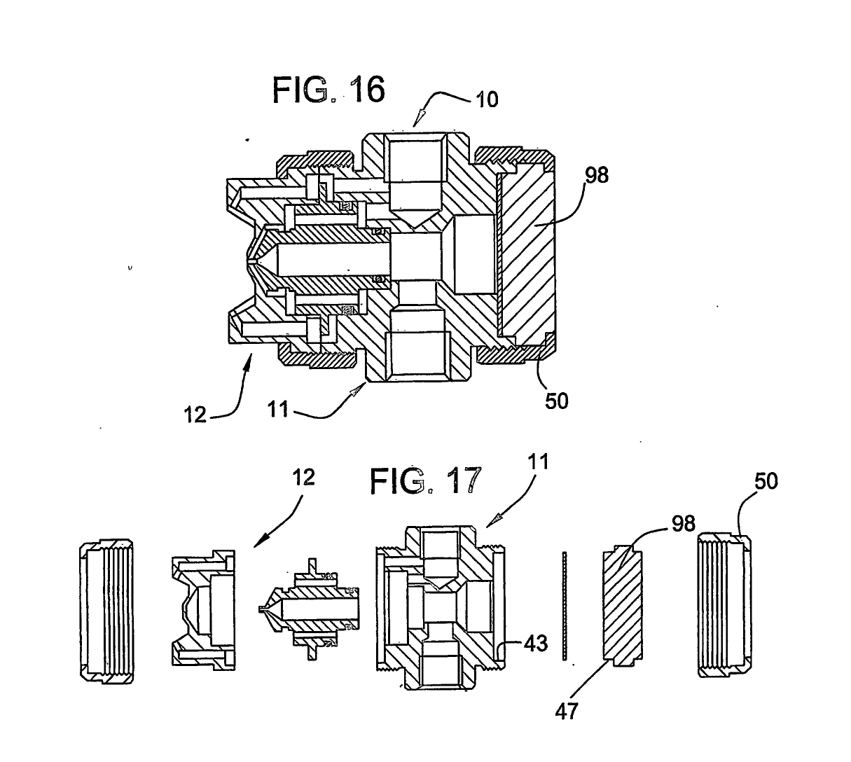

Finally, FIGS. 16 and 17 show the modular spray gun with backup plate 98 removably mounted on the end of the body 11, which enables the spray gun to be used in a liquid spray mode without a control module or accessory.

It can be seen from the foregoing that the modular spray gun of the invention is adapted for quick changeover use with any of a plurality of standardized control modules or accessories. In each case, quick removal and replacement of the control module or accessories is achieved through removal of the retaining ring.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A modular spray gun assembly comprising:
a spray gun body;
a spray nozzle module, the spray nozzle module being releaseably attachable to a downstream end of the nozzle body with a first retainer that engages a portion of the downstream end of the spray gun body; and
a plurality of control modules that are interchangeably mountable on an upstream end of the spray gun body with a portion of each control module being receivable in a counterbore in the upstream end of the spray gun body and releaseably attachable to the spray gun body with a second retainer that engages a portion of the upstream end of the spray gun body.

2. The modular spray gun assembly according to claim 1 wherein the spray nozzle module comprises a spray tip, an air cap mounted in surrounding relation to a discharge end of the spray tip.

3. The modular spray gun assembly according to claim 1 wherein the first retainer is a retaining ring that engages a threaded hub near the downstream end of the spray gun body.

4. The modular spray gun assembly according to claim 1 wherein one of the plurality of control modules includes a reciprocating valve needle having a single action fluid actuatable piston.

5. The modular spray gun assembly according to claim 1 wherein one of the plurality of control modules includes a reciprocating valve needle having a double action fluid actuatable piston.

6. The modular spray gun assembly according to claim 1 wherein one of the plurality of control modules includes a solenoid actuated reciprocating valve needle.

7. The modular spray gun assembly according to claim 1 wherein one of the plurality of control modules comprises a metering needle assembly supported by a mounting plate.

8. The modular spray gun assembly according to claim 1 wherein one of the plurality of control modules comprises a clean out needle assembly supported by a mounting plate.

9. The modular spray gun assembly according to claim 1 wherein one of the plurality of control modules comprises a backup plate supported by a mounting plate.

10. A spray gun assembly comprising:
a spray gun body;
a spray nozzle carried on a downstream end of the spray gun body; and
a plurality of control modules that are interchangeably mountable on an upstream end of the spray gun body with a portion of each control module being receivable in a counterbore in a upstream end of the spray gun body and releaseably attachable to the spray gun body with a second retainer that engages a portion of the upstream end of the spray gun body.
